(19) United States
(12) Patent Application Publication
(10) Pub. No.: US 2005/0249860 A1
(43) Pub. Date: Nov. 10, 2005

(54) Functional fiber flour product and method for making same

(76) Inventors: Jerome Konecsni, Saskatoon (CA); Joe Vidal, Saskatoon (CA); Cameron Kupper, Saskatoon (CA); Petros Loutas, Saskatoon (CA); Martin Reaney, Saskatoon (CA)

Correspondence Address: AMIN LAW, LLC, 217 N. JEFFERSON ST., STE. 500, CHICAGO, IL, 60661, US

(21) Appl. No.: 11/121,530

(22) Filed: May 4, 2005

Related U.S. Application Data
(60) Provisional application No. 60/568,115, filed on May 4, 2004.

(51) Int. Cl. A23L 1/05

(52) U.S. Cl. 426/622

(57) ABSTRACT

The present invention relates to a functional fiber flour product for use in foods, beverages, nutritional products and dietary supplements. The invention includes a functional fiber flour product made from oilseeds and comprises soluble and insoluble dietary fibers, polyunsaturated fatty acids, monounsaturated fatty acids, protein, lignans, and low amounts of digestible carbohydrates and saturated fat. Properties of the present invention are useful in enhancing mixing, sheeting, extrusion, baking, frying and roasting characteristics of human food and beverage products and animal feed products without adversely affecting palatability or appearance attributes; properties also include considerable extended shelf life compared to prior art functional fiber products. The present invention also includes a process for making the functional fiber flour product using high pressure and high temperature mixing and extrusion equipment.

### FIELD OF THE INVENTION

The present invention relates to a functional fiber flour product for use in foods, beverages, nutritional products and dietary supplements. The invention includes a functional fiber flour product made from oilseeds. Benefits of the invention include the presence of soluble and insoluble dietary fibers, polyunsaturated fatty acids, monounsaturated fatty acids, protein, lignans, and low amounts of digestible carbohydrates and saturated fat. The present invention is useful in enhancing mixing, sheeting, extrusion, baking, frying and roasting characteristics of human food and beverage products and animal feed products without adversely affecting palatability or appearance attributes; properties of the present invention include considerable extended shelf life compared to prior art functional fiber products. The present invention also includes a process for making the functional fiber flour product using high pressure and high temperature mixing and extrusion equipment.

### BACKGROUND

The product of foods is an ongoing concern, both for professional dieticians, and the general public alike. Changes in lifestyle and eating habits have meant that more and more of the foods consumed by people are processed rather than freshly prepared. Because of this, there is increasing concern and attention paid by consumers to processed foods in order to help ensure that these foods are meeting their requirements in terms of nutritional value and digestibility.

There are many different dietary philosophies. Most of the published food guides available in Western countries recommend a diet high in fiber, low in fat and modest amounts of protein. Typically, it is recommended that individuals derive most of their food energy from complex carbohydrate sources such as grains and fruits. These same sources are also relatively high in dietary fiber, as well as being low in saturated and trans fats, forms of fat considered to be the most harmful, especially with respect to cardiovascular disease.

In addition to the conventionally accepted diets, there are a variety of alternative diet regimes that have emerged in the last few decades. The interest in diet and dieting is primarily based on the fact that increased affluence in Western society has led to over-consumption of food, the result of which is a significant rise in obesity and in health problems that are related to obesity, such as cardiovascular problems and diabetes. Combined with the increasing costs of providing health care, healthy eating is now seen as an important factor not only for individuals concerned with their personal health, but for those who pay the costs of healthcare like health insurers and governments.

While some diets adhere to the premise that food selection should be towards foods with low fat, and the bulk of energy derived from complex carbohydrates, others have suggested that weight loss is possible by aggressively restricting carbohydrate intake, and consuming mainly protein and fat. Regardless of the relative merits of any particular diet program, it is clear that modern day consumers do make food choices based on the perceived health and dietary benefits of particular foods.

One of the factors that has gained increasing attention recently is the role of fiber in diet and health. The U.S. Surgeon General recommends that a person should consume 20-35 grams of fiber daily, with a recommended daily allowance of 25 grams per the U.S. Food and Drug Administration. The average Western diet is well below this value, with people in Canada and the U.S. typically consuming 10-15 grams daily.

Fiber comes in two forms, soluble and insoluble, which are characterized by both their physical characteristics and their physiological effects. Soluble fiber is soluble in water and comprises food constituents such as gums and pectins. Soluble fiber is considered to provide added health benefits in that it coats the lining of the digestive tract, delaying the emptying of stomach contents and slowing the rate of sugar absorption. The delay in stomach emptying results in a sensation of being full, and thus provides a mechanical feedback that serves to limit appetite. Slowing the rate of sugar absorption reduces demand on the endocrine pancreas, the source of the hormone insulin which is secreted in response to increased blood sugar levels. Moderating insulin levels is known to lead to more stable regulation of blood sugar, which in turn moderates appetite.

In contrast, insoluble fiber is comprised of such things as cellulose and lignins, and is the indigestible portion of foods. Insoluble fiber, as the name suggests, is fiber that does not dissolve in water. This type of fiber adds bulk to food, and improves the ease of movement of food through the digestive tract.

Lignans are members of a class of phytosterols known as phytoestrogens. Lignans are well known for their antioxidant properties, and have been shown to reduce the incidence of some forms of cancer, as well as producing cardioprotective effects in humans. In addition, they possess steroid-like properties and are considered to be beneficial in reducing the symptoms of menopause in women.

Flax seeds are an excellent source of phytosterols known as lignans and are also a rich source of essential fatty acids such as linoleic acid (Omega-6) and alpha-linolenic acid (Omega-3).

In recent years, a variety of diets have become increasingly popular based on a general theme of low carbohydrate and high protein, as well as relatively high fat intake. In general, each of these diets work by switching the body's metabolism from sugar-burning to fat-burning. The typical sources of low carbohydrate foods include meat, eggs, cheese and other similar sources of animal derived protein, which also have very little fiber content. These protein sources are relatively expensive as compared to plant foods sources making this diet more costly than a conventional diet. In addition, there is concern about the potential adverse side effects of a prolonged diet low in fiber and higher in fat than what is customarily recommended by dietary experts. As a result, there is a need and a desire for foods that are relatively low in carbohydrates, while maintaining the desirable characteristics of high fiber and protein, as well as reduced fat.

Those who are health conscious are not just concerned about the energy sources in their foods, but about micronutrients as well. The vitamin and mineral contents of foods are frequently published on labels (with mandatory publication in the U.S.) in order to allow consumers to make more fully informed choices as to their food selections. One class of nutrients of note are the omega-3 fatty acids (OFAs). Typically found at high levels in fish, OFAs have been shown in clinical studies to reduce the risk of cardiovascular disease, to decrease the risks of blood clotting, triglyceride levels, and the growth of atherosclerotic plaques and to lower blood pressure. The American Heart Association recommends that people eat fish three times a week if possible.

There are several disadvantages to fish as a source of OFAs. First, fish is relatively expensive as a protein source, since in many parts of the world, fish is not easily obtainable. In addition, it is known that some types of fish concentrate mercury, which makes repeated and prolonged consumption of fish a potential health risk. Mercury toxicity in humans is well documented, with some of the symptoms including neurological and renal damage, as well as developmental defects in fetuses. As a result, it would be desirable to have a food product relatively high in OFA content, but which is not derived from a fish source and thus avoids the problems associated with consumption of fish.

A further issue with food is stability. As many foods are now stored for long periods and shipped over long distances, a stable food product which does not degrade in quality is highly desirable. The development of off-flavors or odors in foods due to chemical reactions like oxidation can make foods unusable beyond a certain time. Spoilage due to the effect of enzymes or microorganisms can also adversely affect the nutritional value and safety of foods. Products derived from oilseeds are especially vulnerable to degradation due to oxidation of the oils over time, and the oxidation byproducts may render a food product either unpalatable or unsuitable for use.

As with any food product, palatability is of primary importance. Humans are very discriminating in their food preferences with regard to taste, color and texture. Therefore, notwithstanding the nutritional benefits of a food, products quite simply have to be agreeable to the consumer's palate. A problem in prior art processes for producing oilseed products like flax flour has been the inability to produce a product that can be substituted in any significant proportion for wheat or other traditional flours in baked products such as bread, pizza crust, muffins, and the like.

The prior art flax flour, also commonly referred to as defatted flax meal, adversely affects taste, color, and texture of the finished baked product, and also adversely affects binding properties (how the flax flour binds to other baking ingredients Such as salt, sugar, shortening, baking powder, sodas, flavorings, milk and whey powders), baking performance (i.e., leavings, oven jump, and spread), and baking equipment performance (gumming of equipment, bowl pull away, and machinability of the product).

Given the nutritional advantages of using flour products derived from flax, the issue of palatability presents problems for the food product industry looking for wheat flour substitutes that have high fiber, high protein, low saturated and trans fatty acids and low digestible carbohydrate content.

In order to be functional, flax flour must be able to substitute for traditional flours in significant proportions without adversely affecting the palatability of the finished baked product. It is also most desirable that the inclusion of flax flour must not change the handling properties of dough or batter (e.g., machinability or baking performance) if it is to be accepted for use in commercial baking processes, otherwise specialized equipment may be required that would increase the cost of production. Therefore, a functional flax flour product that will behave in a manner analogous to traditional flours, Such that when flax flour is used to replace a portion of the traditional flour, existing means of processing may still be employed, and the finished product will be readily accepted by consumers, is desirable.

An additional requirement for a functional flax flour product is that it should have relatively low oil content. Prior art methods often use a solvent extraction step to remove residual oil remaining after crushing. However, the use of many solvents precludes certification of the resulting product as an “organic” product. As the demand for certified organic food products increases, a higher value flax flour product would be one processed without the use of solvents. While it is possible to use alcohols that have been certified as “organic”, the use of alcohol increases the costs of production.

### SUMMARY OF THE INVENTION

The present invention relates to a functional fiber flour product for use in foods, beverages, nutritional products and dietary supplements. The invention includes a functional fiber flour product made from oilseeds. Benefits of the invention include the presence of soluble and insoluble dietary fibers, polyunsaturated fatty acids, monounsaturated fatty acids, protein, lignans, and low amounts of digestible carbohydrates and saturated fat. More particularly, flax seed is the preferred oilseed for use in the present invention. The present invention also includes a process for making the functional fiber oilseed product using high pressure and high temperature mixing and extrusion equipment.

It is an object of the present invention to provide a functional fiber flax flour product that overcomes problems in the prior art. It is a further object of the present invention to provide a flax flour product such that the flax flour product can be substituted in significant proportions for conventional flours without adversely affecting palatability, baking performance or the appearance of the finished food product. It is a further object of the present invention to provide such flax flour product with extended stability and shelf life, especially in ambient conditions.

It is a further object of the present invention to provide a process for producing the flax flour product that comprises a high pressure and high temperature extruding step between two separate oil expelling steps.

In one embodiment, the invention provides a stable high fiber flax flour product that has useful and superior qualities with respect to palatability, machinability and handling characteristics when used in baking, extrusion, and cooking processes. Preferably, the raw material feed stock used is golden flax seed, rather than the more traditional brown flax seed. The golden flax seed flour product is thus lighter in color, and has reduced off-flavors. The golden flax seed flour product has reduced Omega-3 content and net carbohydrate content, and increased lignan, protein and fiber content compared to prior art flax flours. The flax flour product is stable, with an extended shelf life compared to prior art flax flour, and can be used in significant proportions as a substitute for wheat and other flours, without adversely affecting palatability, machinability, and handling characteristics to produce baked and extruded goods with increased fiber, increased protein, and decreased carbohydrate levels. Such baked and extruded goods also contain nutritionally desirable and elevated levels of omega-3 and lignans not found in most conventional baked and processed food products.

The process used to obtain the fiber flax flour product of the invention includes first a conditioning step, after which the flax seed goes through a first expeller press to remove a portion of oil, producing an initial flax seed cake, followed by an extrusion step, thereby producing an altered flax seed cake. Extrusion involves subjecting the initial flax seed cake exiting the first expeller press to high pressures of approximately 30-40 bar in a screw extruder which raises the temperature of the product to as high as 130° C. and forcing the product out through a die, forming pellets. In conventional food processing, such extruders are used for that purpose, i.e., pelletizing material into a final form for sale as dog food and the like. In the present process, the high temperatures and pressures in the extruder appear to fracture the oil cells and/or perhaps alter the fiber in such a way that the benefits of the product are achieved.

The altered flax seed cake is then pressed again in a second expeller press where more oil is removed, such that the final altered flax seed cake has an oil content of less than 11%. Depending on the situation, the final altered flax seed cake then can be micronized to further kill microorganisms, although the high temperatures in the extruder do kill substantially all bacteria and the like that might be present. The pellets in any event are then milled into the final functional fiber flax flour product and embodied in the present invention.

Simply double pressing the flax seed without extruding could bring the oil content of the final altered flax seed cake down to 10%, however the flax flour resulting therefrom does not have the beneficial and improved properties of stability, palatability and machinability demonstrated by the functional fiber flax flour product of the present invention. Beneficially, the extraction process does not use any solvents such as are commonly used when attempting to decrease oil content. This allows for the functional fiber flax flour product manufactured by the present process to potentially receive a certification labeling the product as organic, and reduces the costs of production that would be added by processing with solvents such as alcohol that are certified as “organic.” Organic foods are becoming increasingly desirable and foods so certified are typically of higher value.

### DETAILED DESCRIPTION

Oilseeds such as flax are recognized as producing seeds with several nutritional characteristics desirable for humans and animals. These include the presence of high fiber, both soluble and insoluble, high protein, and low digestible carbohydrates. In addition, like other plant sources, the fat content is mainly in the form of unsaturated fats, which are more desirable in terms of human health. Flax also contains significant levels of omega-3 fatty acids (OFAs), which have been shown through medical research to have a number of beneficial effects on cardiovascular health in humans, and lignans like secoisolariciresinol diglycoside (SDG). When eaten, SDG is converted in the body to the mammalian lignans enterolactone and enterodiol. These compounds have been shown to provide health benefits, including reducing the risks of cancer and heart disease. In women, lignans have the potential to reduce the symptoms of menopause, as well as reduce the incidence of hormone-related cancers.

In addition, dietary choices have changed over time, and with concerns about obesity and the role of carbohydrates, consumers are seeking out sources of food that are low in carbohydrate but high in protein. Further, the benefits of fiber are also well-documented such that consumers increasingly look for foods with fiber when making choices related to diet.

As a result, the present invention is directed towards producing a flax flour product that combines the aforementioned health benefits, and which can be used in place of a portion of the wheat flour in baking processes and as a substitute for other sources of fiber and protein in food products. The method further provides for a product that is stable and which has an extended shelf life, making it more amenable to storage and transport.

The final functional fiber flax flour product has consistent characteristics with respect to the ability of the flour to be used in the production of batter or dough. Parameters that define the suitability of a flour product include the water absorption properties, mixing ability, texture of the mixed product, the ability to withstand mixing without a loss of structural integrity of the flour particles, the color, flavor and the texture that the flour product imparts to the final baked goods in which it is included. Consistency in these parameters is important to commercial bakers as it permits standardized recipes to be used, which will yield predictable finished products.

Other factors that are important in baking processes are the binding properties of a flour, i.e. how well it binds to other ingredients like salt, sugar, shortening, baking powder, sodas, flavorings, milk, whey powders and the like, baking perfonmance, and interaction with baking equipment. Equipment gumming, bowl pull away and machinability of the product are important considerations, especially in commercial baking operations. Water absorption is also a significant concern in commercial baking. Bread typically achieves water absorption levels of 65-68%, while water absorption in cakes ranges from 25-30%. A flax flour that can achieve similar or better water absorption levels as compared to traditional flours will be desirable as increased water absorption, where taste and texture can be maintained, allows a baked product to be produced at lower cost.

An important requirement for flour products is that of palatability. Palatability includes factors such as taste, flavor and color. Additionally, for a flour to be considered palatable by consumers, it must also provide for a finished baked product with certain characteristics of texture. Some of the desirable texture characteristics include ease of chewing, the graininess of the baked product, and the size and uniformity of the air spaces that develop in a product during the baking process.

In the present case, the flax flour product produced by the described process from flax seed yields a flour product with properties that make it useful in the production of products such as baked goods, pasta, and other processed foods. Golden flax seed feed stock, as opposed to the more common brown flax seed, produces a light colored flour product without the taste associated with brown flax seed. Tests with the flax seed flour product have shown that it is possible to replace about 25% of the wheat flour that would normally be used in bread with the flax flour product of the invention, without significantly affecting the taste or appearance of the finished product. In some foods it has been possible to replace up to 40% of the wheat flour with the flax flour product, while in other foods like pizza crust, the upper limit currently appears to be about 8%.

While golden flax is the preferred feedstock, it is also contemplated that a range of flax flour products can be obtained by using feedstock of golden or brown flax seed or feedstock of varying proportions of golden and brown flax seed. The product could be tailored in color and taste to suit the preferences of an end user.

The flax flour product of the present invention advantageously has a higher water absorption capacity than wheat flour, and so increased water is used when the flax seed flour is blended with wheat flour. To achieve the same consistency of dough, approximately 1.5 to 2 times as much water must be added for each part of flax seed flour product as would be used for the similar amount of wheat flour. An additional 10-25% water can be added where 25% of the wheat flour is replaced with flax seed flour, as compared to a recipe where only wheat flour was used. The ability to absorb more water allows for a greater amount of a baked product containing the flax flour product to be produced from the same amount of starting dry materials.

Although the changes are presently undefined, the processing method including high pressure and high temperature extrusion has apparently caused changes in the flax seed cake, such that the flax seed flour produced from the cake has novel properties that permit its use as a flour replacement in baking, extrusion, and processing without significantly affecting the taste or appearance of the finished product, and without adversely affecting the baking, extrusion or processing performance.

Thus, the present invention provides a functional fiber flax flour product that can be used to produce, in a conventional baking process, baked goods with the nutritional advantages of flax such as increased levels of fiber, protein and lignans, and decreased levels of digestible carbohydrates. While the omega-3 fatty acid content of the product of the present invention is less than that of conventional flax flour, the product allows the production of finished baked, extruded, and processed foods with a significant level of beneficial omega-3 fatty acids.

It is anticipated that the method of the present invention could be practiced using oilseeds other than flax seed to obtain some advantage.

The flax seed flour produced by the present method has been further characterized. The results of these analyses show that a flax seed flour product produced by the process of the invention contains significant amounts of nutrients such as calcium, copper, iron, magnesium niacin, potassium, phosphorous, riboflavin, thiamine and zinc, and is relatively low in sodium.

The functional fiber flax flour product composition of the present invention comprises a dietary fiber component comprising soluble fiber and insoluble fiber, of which lignin is a component. The functional fiber flax flour product composition also comprises a carbohydrate component, which includes the dietary fiber component. The functional fiber flax flour product composition further comprises a fat component comprising at least one polyunsaturated fatty acid, at least one monounsaturated fatty acid, and at least one saturated fatty acid. The functional fiber flax flour product composition also comprises at least one lignan. The functional fiber flax flour product composition further comprises a protein component.

In one preferred embodiment, the dietary fiber component generally comprises more than 30% by weight of the functional fiber flax flour product. The soluble fiber generally comprises one-third of the dietary fiber component. Further, the soluble fiber preferably comprises at least 50% mucilage gum. The insoluble fiber component generally comprises two-thirds of the fiber component and is primarily composed of non-starch polysaccharides such as cellulose and lignins. The ratio of soluble to insoluble dietary fiber is generally about 1:2 to 1:3. The average particle size of the dietary fiber is less than about 250 microns.

In another preferred embodiment, the protein component of the present invention generally comprises more than 30% by weight and has a composition similar to that of soy protein and is gluten free.

In another preferred embodiment, the fat component of the present invention generally comprises less than 15% by weight. The at least one polyunsaturated fatty acid generally comprises more than 7.5% by weight. The 7.5% by weight includes the total amount of polyunsaturated fatty acids that are included in the functional fiber flax flour product composition. The at least one polyunsaturated fatty acid is preferably an omega-3 fatty acid, an omega-6 fatty acid, or a combination of both. If more than one polyunsaturated fatty acid is present, the ratio of omega-3 to omega-6 fatty acids is generally about 3:1 to 4:1. The omega-3 fatty acid preferably comprises alpha-linolenic acid (ALA) and the omega-6 fatty acid preferably comprises linoleic acid. The at least one monounsaturated fat generally comprises more than 1% by weight. The 1% by weight includes the total amount of monounsaturated fats that are included in the functional fiber flax flour product composition. The at least one monounsaturated fat generally comprises oleic acid. The at least one saturated fat generally comprises less than 2% by weight. The 2% by weight includes the total amount of saturated fats that are included in the functional fiber flax flour product composition. In the functional fiber flax flour product composition of the present invention, the at least one lignan generally comprises more than 1.5% by weight, and the at least one lignan preferably comprises secoisolariciresinol diglycoside (SDG). The 1.5% by weight includes the total amount of lignans that are included in the functional fiber flax flour product composition.

In the functional fiber flax flour product composition of the present invention, the carbohydrate component is generally one of digestible carbohydrate material, non-digestible carbohydrate material, or mixtures thereof, and the non-digestible carbohydrate material is one of dietary fiber, non-absorbent carbohydrate material, or mixtures thereof.

The functional fiber flax flour product composition of the invention generally has a water absorption value of 200% or higher as determined by the farinograph method, AACC Method 54-21A, and a viscosity of 600 centipoise or more, as determined on a 15% solution with a Brookfield.RTM. viscometer at 25° C. and a shear rate of 10 sec⁻¹.

Examples of the functional fiber flax flour product composition of the present invention are used for illustrative purposes only, as described herein below:

### EXAMPLE 1

The composition can be mixed with cereal flours in various combinations along with water, salt, fat, and yeast to make a bread dough which may be baked into a bread, pizza, or focaccia product generally having less than 7.0 grams of digestible carbohydrate per 28.35 gm serving, and as low as less than 3.0 grams of digestible carbohydrate per 28.35 gm serving. The bread, pizza, or focaccia product generally has the cell structure and organoleptic properties comparable to conventional bread, pizza, or focaccia, comprising, per 28.35 gm of bread, pizza, or focaccia product: a) at least 5.0 gm protein; b) about 7.0 gm and less of digestible carbohydrate; c) up to 1.6 gm of omega-3 fatty acids and the bread, pizza, or focaccia has a water activity (aw) of more than about 0.80 and less than about 0.95.

### EXAMPLE 2

The composition can be mixed with cereal flours in various combinations along with egg, water, salt, fat, and baking powder to make a batter which may be baked into a cake, muffin, pancake, waffle or crepe product generally having less than 7.0 grams of digestible carbohydrate per 28.35 gm serving, and as low as less than 3.0 grams of digestible carbohydrate per 28.35 gm serving. The cake, muffin, pancake, waffle or crepe product generally has the cell structure and organoleptic properties comparable to conventional cake, muffin, pancake, waffle or crepe, respectively, comprising, per 28.35 gm of said cake, muffin, pancake, waffle or crepe product: a) at least 5.0 gm protein; b) about 7.0 gm and less of digestible carbohydrate; c) up to 1.6 gm of omega-3 fatty acids; and the cake, muffin, pancake, waffle or crepe has a water activity (a_{w}) of more than about 0.80 and less than about 0.95.

### EXAMPLE 3

The composition can also be mixed with cereal flours in various combinations along with water, salt, fat, and yeast to make a pliable dough which may be boiled and baked into a bagel or bialy product generally having less than 7.0 grams of digestible carbohydrate per 28.35 gm serving, and as low as less than 3.0 grams of digestible carbohydrate per 28.35 gm serving. The bagel or bialy product generally has the cell structure and organoleptic properties comparable to conventional bread, comprising, per 28.35 gm of bagel or bialy product: a) at least 5.0 gm protein; b) about 7.0 gm and less of digestible carbohydrate; c) up to 1.6 gm of omega-3 fatty acids; and the bagel or bialy has a water activity (a_{w}) of more than about 0.80 and less than about 0.95.

### EXAMPLE 4

The composition can be mixed with cereal flours in various combinations along with water, egg, vegetable powders, and fat to make a mixture which may be extruded and dried to form a stable pasta or noodle product generally having less than 7.0 grams of digestible carbohydrate per 28.35 gm serving, and as low as less than 3.0 grams of digestible carbohydrate per 28.35 gm serving. The pasta or noodle product generally has the cell structure and organoleptic properties comparable to conventional pasta or noodle, comprising, per 28.35 gm of pasta or noodle product: a) at least 5.0 gm protein; b) about 7.0 gm and less of digestible carbohydrate; c) up to 1.6 gm of omega-3 fatty acids; and the pasta or noodle has a water activity (a_{w}) of more than about 0.80 and less than about 0.95.

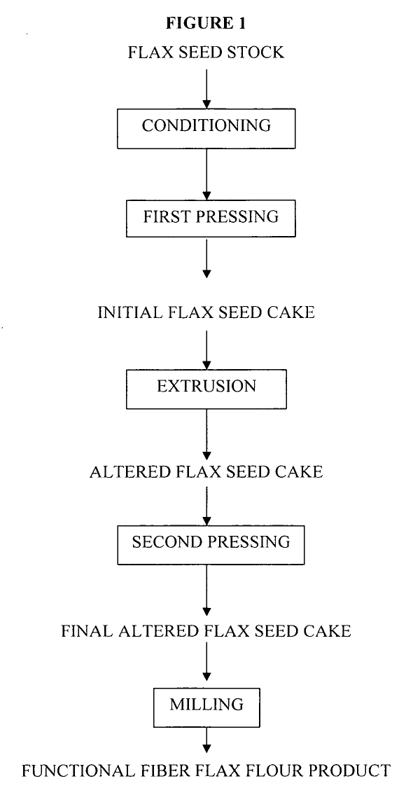

FIG. 1 provides a flowchart illustration of the steps comprising the process of the invention. The individual steps are as follows:

Step 1—Flax Feedstock: Light colored or golden flax seed from storage bins is weighed, and then fed via a rate controlled auger into a seed conditioner. If the flax seed has moisture content greater than 10% it is first dried in a conventional heated-air seed dryer. A control mechanism regulates the speed of the auger, such that a continuous flow process is achieved.

Step 2—Conditioning: The flax seed feedstock is then passed through a seed conditioner where the moisture content is reduced to approximately 8% by stirring and heating the flax seed to about 35-50° C. Such seed conditioners are known in the oilseed processing art.

Step 3—First Pressing to Expel a First Portion of Oil:

Typically flax seed has an oil content of about 40%. After conditioning, the flax seed is pressed in a first expeller press, as is known in the art, to remove a first portion of oil from the flax seed. The oil is collected for conventional use, and the initial flax seed cake exiting the first expeller press has an oil content of about 11-20% by weight. The pressure and friction of the first expeller presser raises the temperature of the initial flax seed cake to about 60° C.

Conventional flax flour or meal is typically made by grinding this initial flax seed cake into flour, however further steps are required to produce the functional fiber flax flour product of the present invention.

Step 4—Extruding:

The initial flax seed cake exiting the first expeller press is then passed through an extruder to produce pellets. The extruder used by the present inventor is an Insta-Pro® Model 2000RC Extruder manufactured by Insta-Pro® International, a division of Triple “F”, Inc. of Des Moines, Iowa, U.S.A. The manufacturer advertises that the extruder is capable of cooking, expanding, sterilizing, dehydrating and texturizing a wide range of products, and states that by creating heat through friction, the Insta-Pro dry extrusion process allows for high heat, short-cook time producing high quality feed and food.

The Insta-Pro® Model 2000RC Extruder is a rotating screw type extruder with a 5¼ inch screw rotating in a 5 5/16 inch barrel. The Model 2000RC Extruder can raise the temperature of the product being extruded to well over 200° C. The screw rotates at about 615 rpm. The cake leaves the extruder through the exit orifice as an altered flax seed cake in the form of pellets.

The temperature of the initial flax seed cake may fall somewhat when moving from the first expeller press to the extruder, but the screw extruder preferably raises the temperature of the initial flax seed cake in the extruder to about 100° C. No oil is removed during the extrusion step, however it appears that some structural changes take place in the initial flax seed cake during this step that beneficially alter the properties of the initial flax seed cake. It appears that extrusion fractures the oil cells, alters the structure of the fiber, or induces some similar alterations in the initial flax seed cake. In any event, the product produced from the extruded seed cake (i.e., the altered flax seed cake) has a longer shelf life than conventional flax flour, and exhibits improved baking performance.

While the above described Insta-Pro® Model 2000RC Extruder has been used to carry out the process, it is contemplated other extruders could be utilized as well to carry out the extruding step. It is also contemplated extruding such that the temperature of the initial flax seed cake in the extruder is increased as high as 130° C. could provide satisfactory results.

Step 5—Second Pressing to Expel a Second Portion of Oil:

The altered flax seed cake is then passed through a second expeller press, where a second portion of oil is expelled. The oil content of the final altered flax seed cake exiting the second expeller press is less than 11% by weight. It is contemplated that further pressing, or pressing under higher pressures could reduce the oil content of the final altered flax seed cake to about 6% or less.

Step 6—Milling:

The final altered flax seed cake can then be micronized with infrared ovens or the like, as is known in the art. The high temperatures of the extrusion process however kills substantially all bacteria and the like, so for many applications micronization may not be required. Similarly other prior art operations such as providing a 100% nitrogen atmosphere during expelling or like operations to reduce oxidation could also be incorporated.

In any event, whether micronized or not, the final altered flax seed cake is then milled conventionally into the functional fiber flax flour product of the present invention. For most applications, the finished functional fiber flax flour product will be milled so that at least 90% of the functional fiber flax flour product passes through a USA mesh size of 20.

It appears that the combination of high pressure and high temperature in the extrusion process is effective to produce changes in the resulting flax seed cake. While the precise chemical and structural changes that occur during processing are not fully understood, it is clear that the process results in modification of the functionality of the fiber and perhaps of other constituents. These modifications result in a functional fiber flax flour product with novel properties that are amenable for use as a substitute for wheat and other cereal-derived flours in baked goods and other processed food products, and that has a substantially longer shelf life stability than prior art milled flax flours. As a result, a functional fiber flax flour product can be produced which retains the nutritional benefits of flax seed, while acquiring novel properties that permit the functional fiber flax flour so produced to be useful in baking operations, or for use in other flour-containing processed food products including pasta and cereals. Flax seed meal or flour produced by prior art crushing methods do not have the necessary properties required to function as an adequate substitute for traditional cereal-derived flours, and do not allow the nutritional benefits of flax seed to be readily enjoyed in common foods.

It is expected that the reduced levels of omega-3 fatty acids in the functional fiber flax flour product of the present invention result from more complete extraction of the oil from the flax seed, as compared to a traditionally milled flax seed meal or flour. In addition, it is thought that the enhancement of the lignan content of the finished product contributes to the stability of the product, as lignans are well known as antioxidants. An advantage here is that no artificial additives are necessary to produce a stable product with the desired functional characteristics, and so the product is capable of designation as an “organic” food product, increasing the value of the functional fiber flax flour so produced.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A process for producing an altered functional fiber flax flour product which comprises the steps of:
conditioning a flax seed;
pressing the flax seed to remove a first portion of oil from the flax seed thereby producing an initial flax seed cake;
extruding the initial flax seed cake wherein the temperature of the initial flax seed cake is increased thereby producing an altered flax seed cake;
pressing the altered flax seed cake wherein a second portion of oil is removed from the altered flax seed cake thereby producing a final altered flax seed cake; and
milling the final altered flax seed cake to produce the functional fiber flax flour product.

2. The process of claim 1 wherein the flax seed is golden flax seed.

3. The process of claim 1 wherein the temperature of the initial flax seed cake is increased as high as 130° C. during extrusion.

4. The process of claim 1 wherein the initial flax seed cake has an oil content between 11-20% by weight.

5. The process of claim 1 wherein the final altered flax seed cake has an oil content less than 11% by weight.

6. The process of claim 1 wherein at least 90% of the altered functional fiber flax flour product passes through a USA mesh size of 20.

7. A functional fiber flax flour product produced by the process of any one of claims 1-6.

8. A method of baking a baked or processed product wherein a portion of traditional flour is replaced with the functional fiber flax flour product of claim 7.

9. The method of claim 8 further comprising storing the functional fiber flax flour product for a period of up to 24 months prior to baking.

10. A baked or processed product produced by any one of claims 8 or 9.

11. A functional fiber flax flour product composition comprising:
a dietary fiber component comprising soluble fiber and insoluble fiber;
a carbohydrate component which includes the dietary fiber component;
a protein component;
a fat component which comprises at least one polyunsaturated fatty acid, at least one monounsaturated fat, and at least one saturated fatty acid; and
at least one lignan.

12. The functional fiber flax flour product composition of claim 11 wherein the dietary fiber component comprises more than 30% by weight.

13. The functional fiber flax flour product composition of claim 11 wherein the soluble fiber comprises one-third of the dietary fiber component.

14. The functional fiber flax flour product composition of claim 11 wherein at least 50% of the soluble fiber is mucilage gum.

15. The functional fiber flax flour product composition of claim 11 wherein the insoluble fiber comprises two-thirds of the dietary fiber component.

16. The functional fiber flax flour product composition of claim 11 wherein the insoluble fiber is composed primarily of non-starch polysaccharides.

17. The functional fiber flax flour product composition of claim 11 wherein the protein component comprises more than 30% by weight.

18. The functional fiber flax flour product composition of claim 17 wherein the composition of the protein component is similar to that of soy protein and is gluten free.

19. The functional fiber flax flour product composition of claim 11 wherein the fat component comprises less than 15% by weight.

20. The functional fiber flax flour product composition of claim 11 wherein the at least one polyunsaturated fatty acid comprises more than 7.5% by weight.

21. The functional fiber flax flour product composition of claim 11 wherein the at least one polyunsaturated fatty acid is an omega-3 fatty acid, an omega-6 fatty acid, or a mixture of an omega-3 fatty acid and an omega-6 fatty acid.

22. The functional fiber flour product composition of claim 21 wherein the ratio of the mixture of the omega-3 fatty acid to the omega-6 fatty acid is about 3:1 to 4:1.

23. The functional fiber flax flour product composition of claim 21 wherein the omega-3 fatty acid is alpha-linolenic acid.

24. The functional fiber flour product composition of claim 21 wherein the omega-6 fatty acid is linoleic acid.

25. The functional fiber flour product composition of claim 11 wherein the at least one monounsaturated fat comprises more than 1% by weight.

26. The functional fiber flour product composition of claim 11 wherein the at least one saturated fatty acid comprises less than 2% by weight.

27. The functional fiber flour product composition of claim 11 wherein the at least one monounsaturated fat comprises oleic acid.

28. The functional fiber flour product composition of claim 11 wherein the at least one lignan comprises more than 1.5% by weight.

29. The functional fiber flour product composition of claim 11 wherein the at least one lignan comprises secoisolariciresinol diglycoside (SDG).

30. The functional fiber flour product composition of claim 11 wherein the ratio of soluble to insoluble dietary fiber is about 1:2 to 1:3.

31. The functional fiber flour product composition of claim 11 wherein the carbohydrate component is selected from the group consisting of digestible carbohydrate material, non-digestible carbohydrate material, and mixtures thereof, and wherein the non-digestible carbohydrate material is selected from dietary fiber, non-absorbent carbohydrate material, and mixtures thereof.

32. The functional fiber flour product composition of claim 11 wherein the average particle size of the dietary fiber component is less than about 250 microns.

33. The functional fiber flour product composition according to claim 11 having a water absorption value of 200% or higher as determined by the farinograph method, AACC Method 54-21A, and a viscosity of 600 centipoise or more, as determined on a 15% solution with a Brookfield RTM viscometer at 25° C. and a shear rate of 10 sec⁻¹.
